(19) United States
(12) Patent Application Publication
(10) Pub. No.: US 2022/0274402 A1
(43) Pub. Date: Sep. 1, 2022

(54) HANDHELD PRINTER

(71) Applicant: Hewlett-Packard Development Company, L.P., Spring, TX (US)

(72) Inventors: Stephen T. Rohman, Vancouver, WA (US); Jody L. Clayburn, Vancouver, WA (US)

(73) Assignee: Hewlett-Packard Development Company, L.P., Spring, TX (US)

(21) Appl. No.: 17/637,486

(22) PCT Filed: Oct. 11, 2019
(86) PCT No.: PCT/US2019/055877

§ 371 Date: Feb. 23, 2022

(51) Int. Cl. B41J 2/14; B41J 3/36

(52) U.S. Cl. CPC B41J 2/1404; B41J 3/36; B41J 2/14201

(57) ABSTRACT

A handheld printer may include an array of fluid ejectors, a sensor to output speed variation signals indicative of variations in speeds of movement amongst the array of fluid ejectors as the handheld printer is moved across a print target;and a controller to output control signals adjusting a relative timing of fluid ejection by the fluid ejectors based on the speed variation signals.

### BACKGROUND

Handheld printers comprise portable printing devices that are manually held and moved across a surface being printed upon. Such handheld printers are sometimes used to print images in the form of text, graphics and the like on surfaces that cannot be fed through a printer.

### BRIEF DESCRIPTION OF THE DRAWINGS

FIG. 1 is a schematic diagram illustrating portions of an example handheld printer being moved in an arc or curve during printing.

FIG. 2 is a schematic diagram illustrating portions of an example handheld printer being moved in an arc or curve during printing.

FIG. 3 is a diagram illustrating potential distortion of an image during printing along a non-linear path or curve.

FIGS. 4A, 4B and 4C are diagrams illustrating potential misalignment of different colors of ink during printing along a non-linear path or curve.

FIG. 5 illustrates an example of color misalignment during printing of a composite color image along a nonlinear path or curve.

FIG. 6 is a diagram illustrating an example of color misalignment and rainbowing during the printing of an image along a nonlinear path or curve.

FIG. 7 is a flow diagram of example handheld printer method for addressing image distortion during printing of an image along a nonlinear path or curve.

FIG. 8 is a schematic diagram illustrating portions of an example handheld printer being moved along a linear path during printing of an example image on a print target.

FIG. 9 is a timing diagram illustrating an example of the timing of fluid ejection by different fluid ejectors during the printing of a composite color pixel of the example image of FIG. 8.

FIG. 10 is a schematic diagram illustrating portions of an example handheld printer being moved along an arc during printing of an example image on a print target.

FIG. 11 is a timing diagram illustrating an example of the timing of fluid ejection by different fluid ejectors during the printing of a composite color pixel of the example image of FIG. 10.

FIG. 12 is a schematic diagram of an example handheld printer and a corresponding graph illustrating interpolation of speeds for different fluid ejectors based upon signals from a pair of spaced encoders.

FIG. 13 is a schematic diagram of an example handheld printer and a corresponding graph illustrating extrapolation of speeds for different fluid ejectors based upon signals from a pair of spaced encoders.

FIG. 14 is a schematic diagram of an example handheld printer for being moved in arc across an example print target.

FIG. 15 is a perspective view illustrating the example handheld printer of FIG. 12 printing on an example uneven surface of an example print target.

FIG. 16 is a side view illustrating the example handheld printer of FIG. 12 printing on an example conical surface of an example print target.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Handheld printers are generally designed to print an image as the handheld printer is linearly moved across a level or flat print medium or print target, wherein the fluid ejectors are all moved at substantially the same speed relative to the print target. As such, handheld printers control the timing of fluid ejection using a single speed sensor, such as a single encoder.

Various circumstances arise where different fluid ejectors of the handheld printer may move at different speeds over and relative to the print target during printing. In such circumstances, controlling the timing of fluid ejection based upon a single sensed speed of the handheld printer may result in distortion of the printed image. For example, attempts to print the image along a nonlinear path, such as along a curve or arc, may result in distortion of the image. Attempts to print the image over an uneven surface, wherein some fluid ejectors travel over a bump and other fluid ejectors do not may result in distortion of the image. Attempts to print the image on a conical surface, wherein some fluid ejectors travel around a larger radius as compared to other fluid ejectors, may result in distortion of the image.

Disclosed are example handheld printers, handheld printer methods and handheld printer instructions that sense or determine speed of movement variations amongst the different fluid ejectors as the fluid ejectors are moved along a nonlinear path, are moved over an uneven or bumpy surface or are moved about a conical surface. The example handheld printers, handle printer methods and handheld printer instructions adjust the timing at which fluid is ejected from the different fluid ejectors based upon the different speeds at which the different fluid ejectors are moved across the print target. As a result, distortion of the image being printed is reduced or eliminated.

Disclosed are example handheld printers, handle printer methods and handheld printer instructions that allow a user to print an otherwise linear or straight image along a user selected, manually maneuvered nonlinear path to dynamically print the otherwise linear image along the nonlinear path with less distortion. The example handheld printers, handle printer methods and handheld printer instructions further allow a user to print an image on an uneven surface or about a conical surface with less distortion. The disclosed example handheld printers, handheld printer methods and handheld printer instructions reduce distortion of the image by sensing and automatically taking into account, in real-time, variations in the speed of movement of different fluid ejectors across the array of fluid ejectors. The disclose example handheld printers, handle printer methods and handheld printer instructions reduce distortion of the image by sensing and automatically take into account, in real-time, variations in the current user chosen nonlinear path of the handheld printer when controlling the timing at which fluid droplets are ejected by the handheld printer.

As a handheld printer is moved along a curve or an arc, those fluid ejectors farthest from a center of the arc travel at a greater speed as compared to those fluid ejectors closer to the center of the arc. Because different fluid ejectors are traversing the print target at different speeds, reliance upon a single speed value, say from a single encoder, to control the timing of fluid ejections by all of the fluid ejectors, regardless of the distance of different fluid ejectors from the center of the arc, may result in an otherwise linear image becoming distorted. For example, the linear image being printed along an arc may be squeezed at the bottom of the image closest to the center of the arc.

In color printing, composite colors are formed by overlapping or coincident deposits of differently colored fluid from different pairs of fluid ejectors. Movement of the handheld printer along the arc or curve causes different pairs of fluid ejectors to travel at different relative speeds. A first pair of the fluid ejectors ejecting two colors of a first composite color pixel and farther away from the center of the arc may traverse the print target at a greater speed as compared to a second pair of ejectors, closer to the center of the arc, that are ejecting the same two colors of to form a second composite color pixel. This difference in relative speeds may result in the two colors of either composite color pixel becoming misaligned, producing a rainbow effect in the pixels and in the image printed along the arc.

The example handheld printers, handheld printer methods and handheld printer instructions reduce such distortion that might otherwise occur by sensing curved movement of an array of fluid ejectors and the associated speed of movement variations amongst different fluid ejectors to adjust the relative timing at which the different fluid ejectors eject fluid based upon the curved movement and based upon the speed of movement variations. The automatic and dynamic adjustment of the relative timing of fluid ejection accounts for the different speeds at which the fluid ejectors travel along the arc. As a result, the person using the handheld printer has a freedom to adjust the printer path to print the otherwise linear image along any combination of linear and non-linear paths with less distortion.

In some implementations, the sensed arcuate or curved path of the fluid ejectors is also used to adjust other aspects of printing to reduce distortion of the linear image being printed along a curve. For example, in some implementations, the number of droplets ejected by different fluid ejectors is adjusted. For example, the number of droplets ejected by those fluid ejectors closer to the center of an arc may be reduced and/or the number of droplets ejected by those fluid ejectors farther away from the center of the arc may be increased.

Disclosed is an example handheld printer that may include an array of fluid ejectors, a sensor to output speed variation signals indicative of speed of movement variations amongst the array of fluid ejectors and a controller to output control signals adjusting a relative timing of fluid ejection by the fluid ejectors based on the speed variation signals.

Disclosed is an example handheld printer method. The method comprises receiving print data for an image, sensing speed of movement variations amongst fluid ejectors of a handheld printer during manual movement of the handheld printer during printing of the image and adjusting a relative timing of fluid ejection by fluid ejectors during printing of the image based upon the sensed speed of movement variations.

Disclosed are example handheld printer instructions. The instructions are provided on a non-transitory computer-readable medium. The instructions are to direct a processor to receive print data for an image, sense speed of movement variations amongst fluid ejectors of a handheld printer during manual movement of the handheld printer during printing of the image and adjust a relative timing of fluid ejection by fluid ejectors during printing of the image as the handheld printer is moved across a print target.

FIG. 1 schematically illustrates an example handheld printer 20 be moved along a non-linear path 22 from a first position 23 to a second position 25 while ejecting fluid, such as ink, to form a curved image 24 in the form of text, graphics or the like. As will be described hereafter, handheld printer 20 prints an otherwise linear or straight image along a user selected, manually maneuvered nonlinear path 22 to dynamically print the otherwise linear image 24 along the nonlinear path 22 with less distortion. Handheld printer 20 reduces distortion of the image by sensing and taking into account the nonlinear path 22 and the resulting beat of movement variations amongst fluid ejectors when controlling the timing at which fluid droplets are ejected by different fluid ejectors of the handheld printer. Handheld printer 20 comprises an array of fluid ejectors 30, a sensor 32 and a controller 34.

Fluid ejectors 30 selectively eject droplets of fluid. In one implementation, fluid ejectors 30 comprise an array of nozzle openings or orifices and a corresponding array of fluid actuators that displace fluid within respective chambers through the nozzle orifices. In one implementation, the fluid ejectors 30 may comprise individual fluid actuators in the form of a thermal resistor which, upon receiving electrical current, heats to a temperature above the nucleation temperature of the fluid so as to vaporize a portion of the adjacent fluid to create a bubble which displaces the fluid through the associated orifice. In other implementations, the fluid ejectors 30 may comprise other forms of fluid actuators. In other implementations, the individual fluid actuators may be in the form of a piezo-membrane based actuator, an electrostatic membrane actuator, mechanical/impact driven membrane actuator, a magneto-strictive drive actuator, an electrochemical actuator, and external laser actuators (that form a bubble through boiling with a laser beam), other such microdevices, or any combination thereof.

In one implementation, the array 30 of fluid ejectors may comprise different fluid ejectors arranged in columns, wherein the different columns of fluid ejectors eject different types or colors of fluid. For example, in one implementation, the array 30 may comprise a first column of fluid ejectors supplied with a first color of ink and a second column of fluid ejector supplied with a second color of ink. In one implementation, the array 30 may comprise multiple columns of fluid ejectors to eject different colors of ink such as cyan, magenta and yellow. Such fluid ejectors may be controlled to eject individual droplets of different colors of fluid on top of and in registration with one another so as to form a composite color pixel.

Sensor 32 outputs speed variation signals that indicate variations in the speed of movement amongst the different fluid ejectors of array 30. Sensor 32 senses both the speed at which printer 20 is manually moved across a print target as well as the shape of the path along which printer 20 is manually moved. By sensing the speed of printer 20 and the shape of the path along which printer 20 is manually moved, sensor 32 outputs signals that may be used to determine different relative speeds of movement amongst the different fluid ejectors.

In the example illustrated, sensor 32 is carried by handheld printer 20. In one implementation, sensor 32 may comprise a pair of individual encoders such as optical encoders or rotary encoder or encoder wheels (which physically contact and roll along the print target) that measure both the speed of printer 20 as well as the angle of movement or trajectory of printer 20. In one implementation, sensor 32 may comprise an accelerometer, multiple accelerometers or a gyroscope for sensing angular motion and velocity of printer 20. In other implementations, sensor 32 may comprise other types of sensors that are capable of sensing angular motion of printer 20. In yet other implementations, sensor 32 may comprise a single optical sensor that senses markings on the print target, in the form of human perceptible or human non-perceptible markings, that provide a coordinate system that may be used to identify curved movement or a nonlinear path of printer 20.

Controller 34 comprises electronics in the form of an integrated circuit or processing unit that carries out programmed instructions or hardwired logic instructions for controlling which fluid ejectors of array 30 eject fluid and the timing at which such fluid ejectors of array 30 eject fluid based upon a received image data file. The received image data file may define an image oriented along a first path or axis. For example, the received image data file may define an image oriented along a linear path such as a horizontal left-to-right linear path.

Controller 34 dynamically adjusts the timing at which the selected fluid ejectors eject fluid to conform printing of the received image data file to the ever-changing and unpredictable actual path of the handheld printer while it is being manually manipulated, maneuvered and moved across the print target. By adjusting the time at which the selected fluid ejectors eject fluid based upon the actual path of the handheld printer, as detected by sensor 32, controller 34 facilitates the printing of the received image data file in any orientation, along any path (not necessarily corresponding to the orientation or shape of the image as defined by the image data file) with less distortion. For example, through simple manual maneuvering of handheld printer along a curve, a horizontal and linear image 24 such as “curved text” may be altered and printed along the curve with less distortion. Although the image 24 is illustrated as being printed along a single arc or curved path, in other implementations, the path may include multiple curves or arcs such as a wave -shaped path.

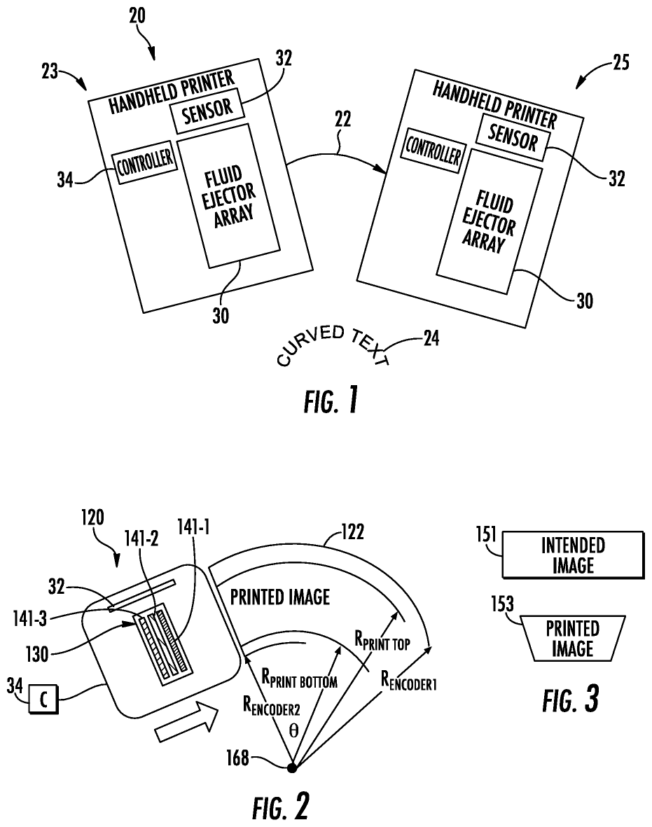

FIG. 2-6 illustrate an example of how printing an image along an arc, without compensating for speed variations amongst the different fluid ejectors, may result in distortion of the printed image. FIG. 2 illustrates portions of an example handheld printer 120 during the printing of an image along a curve or arc 122. Handheld printer 120 is similar to handheld printer 20 described above. Handheld printer 220 comprises an array 130 of fluid ejectors, a sensor 32 and a controller 34 (described above). Array 130 comprises a column 141-1 of fluid ejectors for ejecting cyan colored ink, a column 141-2 of fluid ejectors 142 for ejecting yellow colored ink and a column 141-3 of fluid ejectors 142 for ejecting magenta colored ink.

As shown by FIG. 3, failure to compensate for the different speeds of movement of different fluid ejectors during curved printing may result in an intended image 151 (linearized) being squeezed towards the center of the arc 168, resulting in a distorted printed image 153 (also linearized).

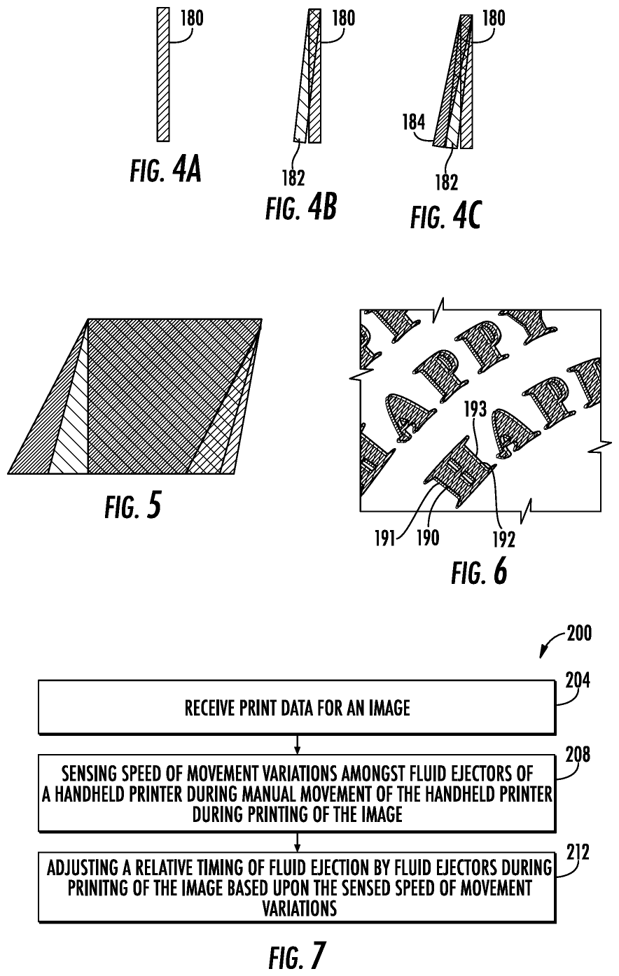

As shown by FIGS. 4-6, failure to compensate for the different speeds of movement of different fluid ejectors during curved printing may also result in misalignment of the different colors of the composite pixels being printed to form the image. FIG. 4A illustrates a first column 180 of cyan ink deposited upon a print medium by column 141-1 during the printing of an image and during movement of printer 120 along arc 122. FIG. 4B illustrates a subsequent deposition of a column 182 of yellow ink. by column 141-2 during the printing of the image as printer 120 is moved along arc 122. FIG. 4C illustrates a subsequent deposition of a column 184 of magenta ink by column 141-3 during the printing of the image as printer 220 is moved along arc 222. In the example illustrated, each of the columns 180, 182 and 184 were to be directly aligned on top of one another pursuant to the image data. However, because handheld printer 120 was moved along arc 122, those fluid ejectors closest to the center 168 of the arc travel at a slower speed. As a result, the lower end of columns 182 and 184 of yellow and magenta ink were printed before the corresponding fluid ejectors could be aligned with the previously deposited columns. As a result, the rainbow effect (linearized) shown in FIG. 5 results.

FIG. 6 illustrates an example of the rainbow effect during the printing of the image “HAPPY” during movement of handheld printer 120 along an arc. As shown by FIG. 6, the left edge 190 of each letter is preceded by magenta color print 191 and the right edge 192 of each letter is succeeded by cyan color print 193.

As described above, controller 34 reduces or eliminates the above described distortions by sensing the nonlinear movement of handheld printers 20 and 120 and automatically adjusting the timing of fluid ejection based upon speed of movement variations amongst the fluid ejectors as indicated by the sensed nonlinear movement. FIG. 7 is a flow diagram of an example handheld printer method 200 that may be carried out by handheld printer 120 to address the distortions described above. Method 200 facilitates a printing of an image along a user selected, manually maneuvered nonlinear path to dynamically print the image along the nonlinear path with less distortion. Although method 200 is described in the context of being carried out by printer 120 described above, method 200 may be likewise carried out by handheld printer 20, any of the handheld printers described hereafter or with any other similar handheld printers.

As indicated by block 204, handheld printer 120 receives print data for an image to be printed. The image may be in the form of graphics, text or combinations thereof. The image file serves as a basis for controlling fluid ejection by fluid ejectors of the handheld printer 120. The image file serves as a basis for controlling which fluid ejectors are to eject fluid at particular points in time and the timing of such fluid ejections.

As indicated by block 208, sensor 32 senses speed of movement variations amongst fluid ejectors of a handheld printer during manual movement of the handheld printer during printing of the image. In the example, sensor 32 senses manual movement of the handheld printer 20 along a curved path during printing of the image with the handheld printer 120. In one implementation, sensor 32 senses to speeds at two different locations and interpolates or extrapolates differences in the two speeds to determine the speed of the different fluid ejectors. In another implementation, sensor 32 senses the arcuate motion and uses the arcuate motion in combination with a sensed speed value to determine the different speeds of the different fluid ejectors based upon their distance from a center of the identified arc. As noted above, such sensing may be carried out using a pair of encoders, an accelerometer, a group of accelerometers, a gyroscope, an optical sensor that senses substantially in perceptible markings on the print target itself or other forms of sensors.

As indicated by block 212, controller 34 adjusts a relative timing of fluid ejection by fluid ejectors during printing of the image based upon the sensed speed of movement variations. In the example, sensor 32 senses manual movement of the handheld printer along the curved path and adjusts a relative timing of fluid ejection by the fluid ejectors during printing of the image. By adjusting the relative timing of fluid ejection based upon the sensed curved path, controller 34 reduces distortion of the image being printed. For example, lower portions of image towards the center of the arc are squeezed or compacted to a lesser extent. In addition, different colors of fluid or ink, intended to be deposited directly on top of one another so as to form a composite color may be more accurately registered and aligned with one another.

FIG. 8 illustrates portions of an example handheld printer 220 during the printing of an image 24 on a print target 221 as the handheld printer 220 is moved along a linear path across print target 221. Print target 221 may comprise any structure having a surface to be printed upon. The structure may be in the form of a sheet or web of print medium, such as a sheet or web of paper. The structure forming print target 221 may also be in the form of a box or other container. The structure forming print target 221 may be in the form of a three-dimensional object or article which is to be printed upon.

Handheld printer 220 comprises fluid ejectors array 230, fluid supplies 231-1, 231-2 and 231-3 (collectively referred to as fluid supplies 231), sensor 32 (described above) and controller 234. Array 230 comprises fluid ejectors 242-1-1, 242-1-2, 242-2-1, 242-2-2, 242-3-1 and 242-3-2 (collectively referred to as ejectors 242). Each individual fluid ejection 242 comprises a fluid ejection chamber 244, an ejection nozzle or orifice 246 and a fluid actuator 248. Fluid ejection chamber 244 of each fluid ejector 242 comprises an empty volume which is to receive fluid from an associated fluid supply. Each orifice 246 comprises an opening extending from the associated ejection chamber and through which fluid is injected, generally as droplets. Each fluid actuator 248 comprises a device that displaces fluid within the fluid ejection chamber 244 through the orifice 246 in response to electrical pulses or control signals provided by controller 234.

In one implementation, fluid actuator 248 comprise a thermal resistor which, upon receiving electrical current, heats to a temperature above the nucleation temperature of the fluid so as to vaporize a portion of the adjacent fluid to create a bubble which displaces the fluid through the associated orifice 246. In other implementations, the fluid actuator 248 may comprise other forms of fluid actuators. In other implementations, the fluid actuator 248 may comprise a fluid actuator in the form of a piezo-membrane based actuator, an electrostatic membrane actuator, mechanical/impact driven membrane actuator, a magneto-strictive drive actuator, an electrochemical actuator, and external laser actuators (that form a bubble through boiling with a laser beam), other such microdevices, or any combination thereof.

Fluid ejectors 242 are arranged in three different columns 241-1, 241-2 and 241-3, with each column of fluid ejectors 242 ejecting a single color of fluid or ink as supplied by corresponding fluid supply 231-1, 231-2 and 231-3, respectively. In one implementation, fluid ejectors 242 of column 241-1 eject a magenta colored ink. Fluid ejectors 242 of column 241-2 eject a yellow colored ink. Fluid ejectors 242 of column 241-3 eject a magenta colored ink. As further shown by FIG. 8, the fluid ejectors 242 of the different columns 231 also form a pair of rows 243-1 and 243-2. Although two rows of fluid ejectors are illustrated, handheld printer 220 may include a much larger number of such rows.

Controller 234 is similar to controller 34 described above. Controller 234 comprises a processing unit 250 and a memory 252. Processing unit 250 carries out instructions contained in memory 252. Memory 252 comprising non-transitory computer-readable medium which provides instructions to processing unit 250. Memory 252 may be in the form of software or an integrated circuit having logic elements. The instructions contained in memory 252 direct processing unit 250 to output control signals controlling the timing at which different individual fluid ejectors 242 eject the respective colors of fluid onto a print target.

The instructions contained in memory 252 direct processing unit 250 to generate such control signals through analysis of received image data and based upon signals from sensor 32 indicating the current path being taken by handheld printer 220 across print target. In another implementation, the image data may be analyzed remote from handheld printer 220, wherein results of the analysis are communicated to handheld printer 220 for use by controller 234 to generate and output the control signals that control the timing at which fluid is ejected by the different fluid ejectors 242. In such an implementation, controller 234 may generate the control signals based upon the remotely generated results of image data analysis and based upon signals from sensor 32 indicating the current path being taken by the handheld printer 120 across print target. The current path may then be utilized to determine the different speeds at which the different fluid ejectors are crossing the print target 221.

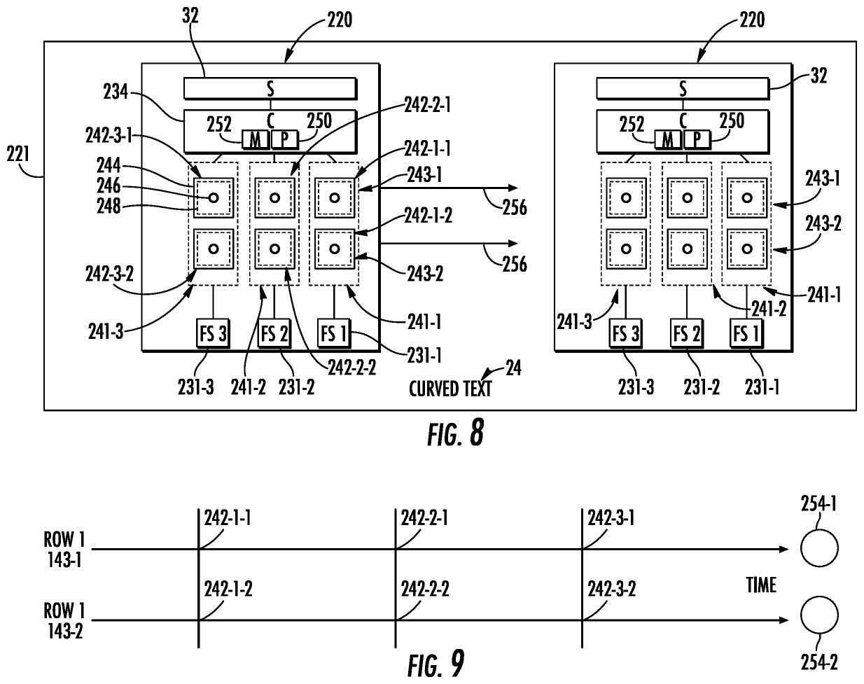

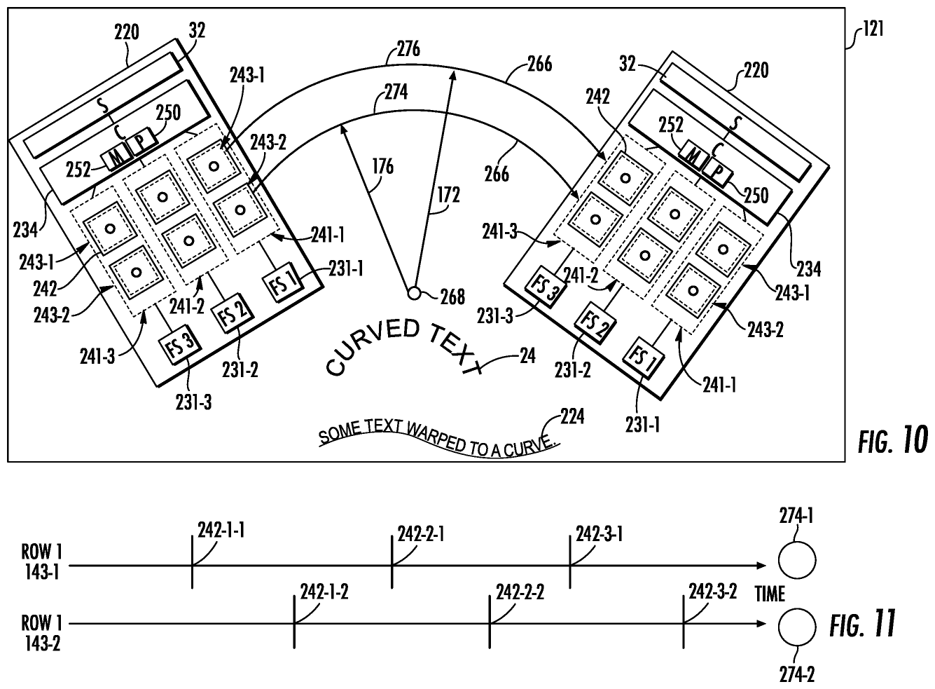

FIG. 9 is a diagram illustrating an example of the timing of fluid ejection by the different fluid ejectors 242 to form to individual composite color pixels 254-1 and 254-2 of image 24. As shown by FIG. 8, image 24 is printed by handle printer 220 as handheld printer 220 is generally moved across print target 221 in a linear fashion as indicated by arrows 256. During such printing, rows 243-1 and 243-2 of fluid ejectors 242 move across print target 221 relative to the print target 221 at the same speed. As a result, to form composite color pixel 254-1, controller 234 outputs control signals causing fluid ejector 242-1-1 to deposit a droplet of cyan ink. Based upon the sensed speed of handheld printer 220 and the spacing of columns 241-1 and 241-2, controller 234 outputs control signals causing fluid ejector 242-2-1 to deposit a droplet of yellow ink directly on top of the previously deposited droplet of cyan ink. Based upon the sensed speed of handheld printer 220 and the spacing of columns 241-2 and 241-3, controller outputs control signals causing fluid ejector 242-3-1 to deposit a droplet of magenta ink directly on top of the previously deposited droplet of yellow ink.

To form a second composite color pixel 254-2 of image 24, controller 234 outputs control signals causing fluid ejector 242-1-2 to deposit a droplet of cyan ink. Based upon the sensed speed of handheld printer 220 and the spacing of columns 241-1 and 241-2, controller 234 outputs control signals causing fluid ejector 242-2-2 to deposit a droplet of yellow ink directly on top of the previously deposited droplet of cyan ink. Based upon the sensed speed of handheld printer 220 and the spacing of columns 241-2 and 241-3, controller outputs control signals causing fluid ejector 242-3-2 to deposit a droplet of magenta ink directly on top of the previously deposited droplet of yellow ink. Because signals from sensor 32 indicate linear movement of handheld printer 220 relative to and across the print target 221, the timing of fluid ejection by both of rows 243 may be based upon a single speed value. As will be described hereafter, when image 24 is being printed along a non-linear path, controller 234 utilizes different speed values for the different rows when controlling the timing of fluid ejection.

FIG. 10 illustrates handheld printer 120 printing the same image 24 from the same image data file along a nonlinear path, an arcuate or curved path as indicated by arrows 266. Due to the non-linear path through which handheld printer 220 is manually moved, row 243-1 of fluid ejectors 242 traverses print medium 221 at a speed greater than the speed at which row 243-2 traverses the same print medium 221. The difference in speeds is based upon the different radial distances at which the different rows 243 are spaced from the center 268 of the curve or arc indicated by arrow 266. In the example illustrated, row 243-1 of fluid ejectors 242 moves along an arc 270 having a radius 272. At the same time, row 243-2 of fluid ejectors 242 moves along an arc 274 having a radius 276.

As shown by FIG. 10, controller 234 outputs control signals adjusting the timing of fluid ejection by the fluid ejectors 242 of the different rows 243 based upon the differences in their speed which is based upon the differences in the radii 272, 276 from the center 268 of the arcs. In particular, controller 234 may use signals from sensor 32 to determine the angular movement of handheld printer 220 and the corresponding radii of the different rows 243 from the center of the arc. The arc length traveled during a period of time by each of the rows 243 may then be used to determine the speed of the fluid ejectors of each of rows 243. Arc length is determined according to the formula R*(279/360). Controller 234 may then adjust the timing of its control signals causing a delay in the ejection of fluid by those fluid ejectors 242 of rows closer to center 268 and traveling at a slower speed such that the drops of different colored ink deposited by the fluid ejectors of the same row more closely align and register on top of one another to form the composite color.

FIG. 11 is a diagram illustrating an example of the timing of fluid ejection by the different fluid ejectors 242 to form to individual composite color pixels 274-1 and 274-2 of image 24. As shown by the example illustrated in FIG. 11, controller 234 outputs control signal such that the fluid ejection by each of fluid ejectors 242-1-2, 242-2-2 and 242-3-2 is delayed or occurs following fluid ejection by fluid ejectors 242-1-1, 242-2-1 and 242-3-1, respectively, of the same respective columns. For example, the ejection of fluid by fluid ejector 242-1-2 in column 241-1 occurs after the ejection of fluid by ejector 242-1-1 of the same column 241-1. This delay for those fluid ejectors of row 243-2 relative to those fluid ejectors of row 243-1 compensates for the slower speed at which row 143-2 moves across print target 221 such that the drops of the different colored ink ejected by the fluid ejectors 242 of row 243-2 are registered on top of one another to form the composite color pixel 274-2. In other words, the delay provides fluid ejector 242-2-2 sufficient time so as to be moved directly over the drop of ink previously deposited by ejector 242-1-2 before ejecting its droplet of ink. Likewise, the delay provides fluid ejector 242-3-2 sufficient time so as to be moved over the drop of ink previously deposited by ejector 241-2-2 before ejecting its droplet of ink.

In one implementation, the sensed arcuate or curved path of the fluid ejectors 242 is also used by controller 234 to adjust other aspects of printing to reduce distortion of the linear image being printed along a curve. For example, in some implementations, controller 234 adjust the number of droplets ejected by different fluid ejectors. For example, controller 234 reduces the number of droplets ejected by those fluid ejectors closer to the center of an arc and/or increases the number of droplets ejected by those fluid ejectors farther away from the center of the arc. In one implementation, controller 234 increase the number of fluid ejections are the density of flute ejections by those rows of flute ejections 242 further away from the center 268 of the arc or curve along which handheld printer 220 is being moved.

As further shown by FIG. 10, handheld printer 220 may be manually moved through a series of multiple different arcs during the printing of an image. In the example illustrated, handheld printer 220 is moved through a series of arc so as to print the image 224 comprising the text “some text warped to a curve.” As handheld printer 220 moves through the different curves, sensor 32 continuously senses the current arc and the current radii of the different rows of fluid ejectors 242, wherein the timing at which fluid is ejected by the fluid ejectors of the different rows is continuously and repeatedly adjusted based upon the ongoing changes to the path along which handheld printer 220 is moved.

FIG. 12 illustrates an example handheld printer 320. FIG. 12 further illustrates an example of how curved movement of printer 320 may be detected so as to determine the different relative positions or speeds of the various fluid ejectors for use in adjusting the timing of fluid ejection by such fluid ejectors. Handheld printer 320 is similar to handheld printers 120 and 220 described above except that handheld printer 320 is specifically illustrated as comprising a sensor 332 in the form of a pair of encoders 381-1 and 381-2 (collectively referred to as encoders 381) on opposite ends of array 130 of fluid ejectors 242 (shown and described in more detail in FIG. 8). Encoders 381 may comprise optical encoders or encoder wheels that physically contact the print target and row along the surface of the print target to output signals indicating the relative movement of the particular encoder 381 with respect to the surface of the print target. Signals from encoders 381 may indicate non-linear or curved movement of handheld printer 320 in circumstances where encoder 381-1 indicates a first speed of handheld printer 320 relative to the print target and where encoder 381-2 indicates a second different speed of handheld printer 320 relative to the print target.

The right side of FIG. 12 illustrates changes in the positioning of encoders 381 after movement of handheld printer 320 during a predetermined period of time. As shown by FIG. 12, after such movement, encoder 381-1 is at a first position 384 while encoder 31-2 is at a second position 386. The differences in the positions indicate the different relative velocities of encoders 381. This difference indicates movement of handheld printer 320 along an arc, wherein encoder 381-1 is farther away from the center of the art as compared to encoder 381-2. The differences may be used by controller 34 to determine the arc and it center.

As further shown on the right side of FIG. 12, based upon the differences in the relative velocities of encoders 381, controller 34 may determine the different speeds of the different fluid ejectors or the different speeds of the different rows of fluid ejectors 242 through linear interpolation. As described above, controller 34 may then adjust the relative timing of fluid ejection by the different fluid ejectors based upon the different determined speeds at which the different fluid ejectors 242 are moved across print target. In some implementations, controller 34 may determine the individual speed for each individual row 143 (described above with respect to FIG. 8) of fluid ejectors and then individually adjust the timing of fluid ejection by the fluid ejectors of each individual row based upon its respective speed (in a fashion similar to described above with respect to FIG. 11).

In the example illustrated in FIG. 12, processing demands are reduced by subdividing the columns of fluid ejectors 242 into different fluid ejector groups 390-1, 390-2, 390-3, 390-4, 390-5, 390-6, 390-7 and 390-8 (collectively referred to as groups 390). Each fluid ejector group 390 comprises a subset of the larger set of fluid ejectors along each column 141 of fluid ejectors. Each fluid ejector group 390 comprises a row of fluid ejectors including those fluid ejectors of the subset in each of columns 141-1, 141-2 and 141-3.

Rather than determining the relative speed of each individual fluid ejector or row fluid ejectors relative to the print target and adjusting the timing of fluid ejection by the individual rows of fluid ejectors 242, controller 34 may determine the relative speed for each group 390 of fluid ejectors and then uniformly adjust the timing of fluid ejection by each of the fluid ejectors 242 of each group based upon the speed used for the group 390. For example, controller 34 may interpolate a speed for a middle fluid ejector in the group 390-2 of fluid ejectors and use the interpolated speed for all of the fluid ejectors of the group 392 to adjust the timing of fluid ejection by the fluid ejectors ejecting cyan, yellow and magenta inks across the row of fluid ejectors in group 390-2. By way of another example, controller 34 may interpolate a speed for each of the fluid ejectors of the group and then utilize the average of the speeds to adjust the timing of the fluid ejection by the fluid ejectors.

FIG. 13 schematically illustrates portions of an example handheld printer 420. The right side of FIG. 13 further illustrates different position signals from the different encoders 181 of printer 420 during movement of handheld printer 420 along an arc or curve. FIG. 13 illustrates another example of how curved movement of printer 420 may be detected so as to determine the different relative positions or speeds of the various fluid ejectors for use in adjusting the timing of fluid ejection by such fluid ejectors. FIG. 13 illustrates the use of extrapolation to determine the different relative positions or speeds of the various fluid ejectors.

Handheld printer 420 is similar to handheld printer 320 except that encoders 381 are located on a single end of the array 130 of fluid ejectors 242. As shown on the right side of FIG. 12, rather than interpolating the position signals from encoders 381 t to determine the different positions and/or relative speeds of the different fluid ejectors 242 (or groups of fluid ejectors 242), controller 34 uses the spacing between encoders 381 and the signals from encoders 381 to extrapolate velocity or position values for the different fluid ejection 242 along each column 141 or different groups 390 of fluid ejectors along each column 141. As described above with respect to FIGS. 10 and 11, controller 34 may then use the different determined speeds of the different fluid ejectors or group of fluid ejectors to adjust the relative timing of fluid ejection by each of the fluid ejectors or groups of fluid ejectors relative to one another along each column 141. As should be appreciated, the above-described use of interpolation and extrapolation by controller 34 to determine the different speeds of the different fluid ejectors may likewise be utilized with other forms of sensors such as accelerometers.

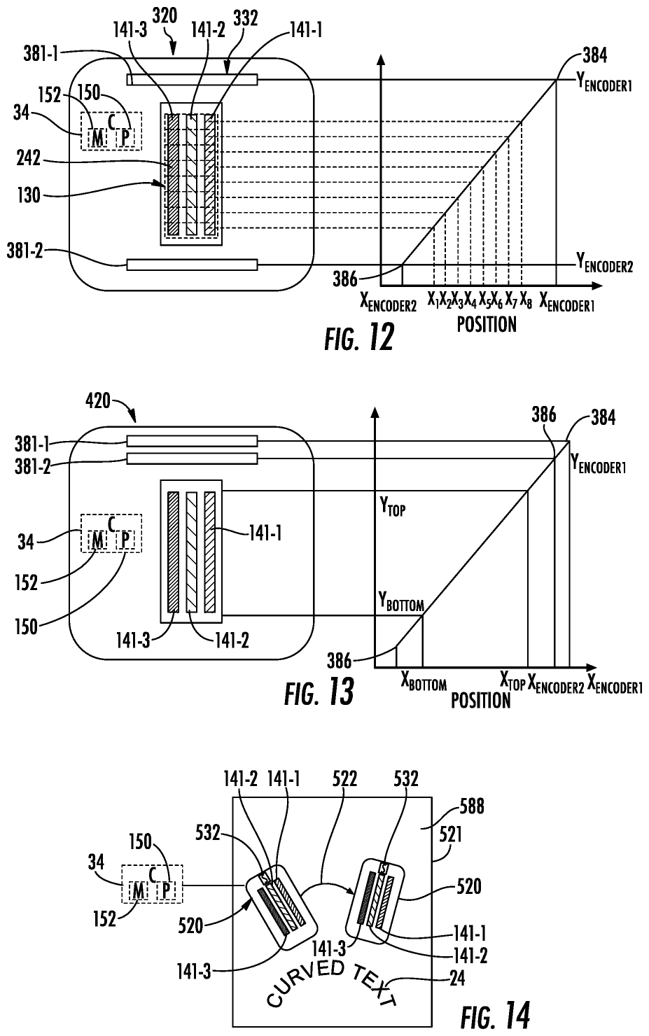

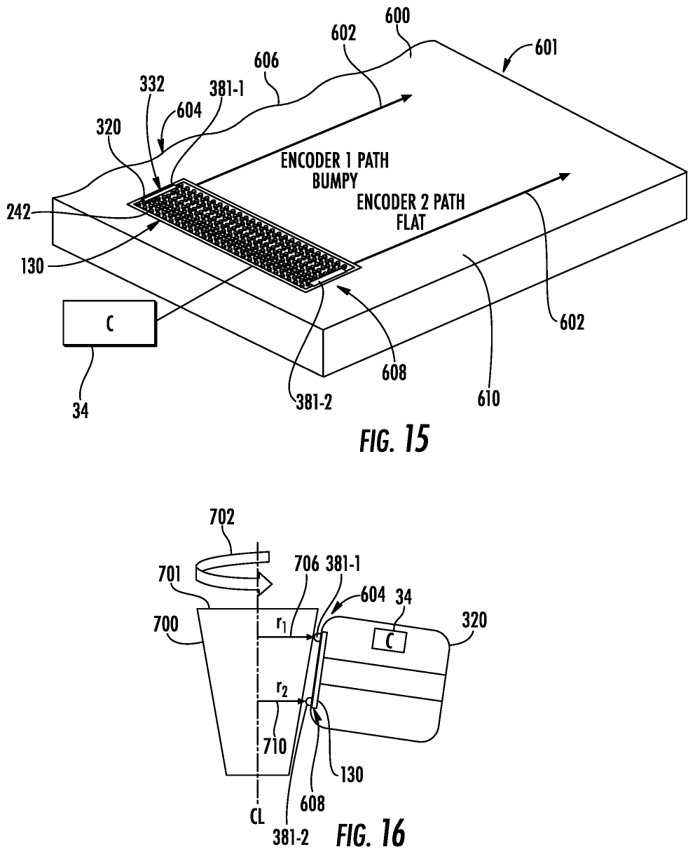

FIG. 14 schematically illustrates portions of an example handheld printer 520 being moved along a nonlinear path, comprising an arc 522, during printing of image 24. FIG. 13 illustrates how curved movement of a handheld printer across print medium may be detected and utilized to determine different relative speeds of different fluid ejectors for adjusting the timing of fluid ejection by the different fluid ejectors.

Handheld printer 520 is similar to handheld printers 120 and 220 described above except that handheld printer 520 comprises sensor 532. Sensor 532 comprises an optical sensor that senses coordinate markings 588 provided on print target 521. Such markings may be in the form of a two-dimensional array or grid of dots. Such markings 588 may be perceptible or imperceptible to the human eye. Such markings 588 provide a coordinate system that may be sensed by sensor 532 and which may be used by controller 34 to determine non-linear movement of handheld printer 520 across print target 521. For example, controller 34 may utilize a predetermined spacing of such dots and the optically captured number of dots traversed by handheld printer 520 two determine curved movement of handheld printer 520 and the corresponding different speeds at which the different fluid ejectors are crossing print target 521. The different speeds may then be used to adjust the relative timing of fluid ejection by the different fluid ejectors as described above.

FIG. 15 is a perspective view illustrating handheld printer 320 (described above) printing across an uneven or unlevel surface 600 of a print target 601. During movement of handheld printer 320 in the direction indicated by arrows 602, a first end 604 of handheld printer 320 is manually moved across a bumpy terrain 606 while a second opposite end 608 of handout printer 320 moves across a less bumpy are even flat terrain 610. The different terrains 606 and 610 may result in the fluid ejectors 242 of array 130 proximate to end 604 moving at a greater speed relative to the print target 601 as compared to those fluid ejectors 242 of array 130 proximate to end 608.

During such movement, encoders 381-1 and 381-2 of sensor 332 detect the relative movement across surface 600 and output speed variation signals indicating the different speeds of movement amongst the different fluid ejectors 242. In the example illustrated, encoder 381-1 outputs signals indicating the speed of movement for those fluid ejectors proximate to end 604 while encoder 381-2 outputs signals indicating the speed of movement for those fluid ejectors proximate to end 608. The speed at which the fluid ejectors 242 between encoder 381-1 and 381-2 move may be interpolated as described above with respect to FIG. 12. Based upon the different speeds at which the different fluid objects move across surface 600, controller 34 adjusts the timing at which fluid is ejected by the fluid ejectors 242 to reduce distortion of the image being printed. For example, as described above, the timing of fluid ejections by different fluid ejectors may be adjusted to facilitate alignment and registration of different colors of ink droplets that are to form a composite color pixel or image, avoiding or reducing rainbowing. As should be appreciated, any of the above described handheld printers having other types or arrangements of sensors may similarly adjust the timing at which the different fluid ejectors eject fluid to reduce distortion.

FIG. 16 is a side view illustrating handheld printer 320 (described above) printing an image about a conical surface 700 of a print target 701. During movement of handheld printer 320 in the direction indicated by arrow 702, a first end 604 of handheld printer 320 is manually moved about a first radius 706 while a second opposite end 608 of handout printer 320 moves across second smaller radius 710. The different radii may result in the fluid ejectors 242 of array 130 proximate to end 604 moving at a greater speed relative to the print target 701 as compared to those fluid ejectors 242 of array 130 proximate to end 608.

During such movement, encoders 381-1 and 381-2 of sensor 332 detect the relative movement across surface 700 and output speed variation signals indicating the different speed of movement by the different fluid ejectors 242. In the example illustrated, encoder 381-1 output signals indicating the speed of movement for those fluid ejectors proximate to end 604 while encoder 381-2 output signals indicating the speed of movement for those fluid ejectors proximate to end 608. The speed at which the fluid ejectors 242 between encoder 381-1 and 381-2 move may be interpolated as described above with respect to FIG. 12. Based upon the different speeds at which the different fluid objects move across surface 600, controller 34 adjusts the timing at which fluid is ejected by the fluid ejectors 242 to reduce distortion of the image being printed. For example, as described above, the timing of fluid ejections by different fluid ejectors may be adjusted to facilitate alignment and registration of different colors of ink droplets that are to form a composite color pixel or image, thereby avoiding or reducing rainbowing. As should be appreciated, any of the above described handheld printers having other types or arrangements of sensors may similarly adjust the timing at which the different fluid ejectors eject fluid to reduce distortion.

Although the present disclosure has been described with reference to example implementations, workers skilled in the art will recognize that changes may be made in form and detail without departing from disclosure. For example, although different example implementations may have been described as including features providing various benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A handheld printer comprising:
an array of fluid ejectors;
a sensor to output speed variation signals indicative of variations in speeds of movement amongst the array of fluid ejectors as the handheld printer is moved across a print target; and
a controller to output control signals adjusting a relative timing of fluid ejection by the fluid ejectors based on the speed variation signals.

2. The handheld printer of claim 1, wherein the movement of the handheld printer is about a curve having a center and wherein the control signals adjust the relative timing of fluid ejection by a first pair of the fluid ejectors with respect to the relative timing of fluid ejection by a second pair of the fluid ejectors based upon different radial spacings of the first pair of fluid ejectors and the second pair of fluid ejectors from the center.

3. The handheld printer of claim 2, wherein the relative timing of fluid ejection of the first pair of the fluid ejectors is adjusted such that different droplets of fluid ejected by the first pair are aligned on top of one another and wherein the relative timing of fluid ejection of the second pair of fluid ejectors is adjusted such that different droplets of fluid ejected by the second pair are aligned on top of one another.

4. The handheld printer of claim 3, wherein the array of fluid ejectors comprises a first column of fluid ejectors to eject a first color of fluid and a second column of fluid ejectors to eject a second color of fluid, the second color being different than the first color, wherein the first pair of fluid ejectors comprises a first ejector and a second ejector in the first column and the second column, respectively, and wherein the second pair of fluid ejectors comprises a third ejector and a fourth ejector in the first column and the second column, respectively.

5. The handheld printer of claim 1, wherein the control signals adjust the relative timing of fluid ejection by a first pair of the fluid ejectors with respect to the relative timing of fluid ejection by a second pair of the fluid ejectors based upon a first distance traveled by the first pair of fluid ejectors during a period of time relative to a second greater distance traveled by the second pair of the fluid ejectors during the period of time.

6. The handheld printer of claim 5, wherein the array of fluid ejectors comprises a first column of fluid ejectors to eject a first color of fluid and a second column of fluid ejectors to eject a second color of fluid, the second color being different than the first color, wherein the first pair of fluid ejectors comprises a first ejector and a second ejector in the first column and the second column, respectively, and wherein the second pair of fluid ejectors comprises a third ejector and a fourth ejector in the first column and the second column, respectively.

7. The handheld printer claim 1, wherein the controller is to receive print data for printing an image oriented along a linear axis, wherein printing of the image along the linear axis would otherwise result in a first fluid ejector ejecting a first drop of fluid on top of a second drop of fluid ejected by a second fluid ejector, the second drop of fluid being ejected a first period of time prior to ejection of the first drop of fluid and wherein during printing of the image, the control signals output by the controller based on the speed variation signals are to cause the first fluid ejector to eject the first drop of fluid on top of the second drop of fluid ejected by a second fluid ejector a second different period of time prior to ejection of the first drop.

8. The handheld printer of claim 1, wherein the sensor comprises a first encoder and a second encoder to detect relative movement of array of fluid ejectors and a print target, the second encoder being spaced from the first encoder.

9. The handheld printer of claim 8, wherein the array of fluid ejectors are arranged along an axis, wherein the first encoder is proximate a first end of the array along the axis, wherein the second encoder is proximate a second end of the array along the axis, wherein the control signals output by the controller adjusting the relative timing of fluid ejection by the fluid ejectors between the first encoder and the second encoder are based upon an interpolation of data from the first encoder and the second encoder.

10. The handheld printer of claim 8, wherein the array of fluid ejectors has a first end and a second end along an axis, wherein the first encoder and the second encoder are proximate the first end, wherein the control signals output by the controller adjusting the relative timing of fluid ejection by the fluid ejectors are based upon an extrapolation of data from the first encoder and the second encoder.

11. The handheld printer of claim 8, wherein the first encoder and the second encoder are selected from a group of encoders consisting of an encoder wheel and an optical encoder.

12. The handheld printer of claim 1, wherein the controller is to output second control signals adjusting a number of droplets ejected by the fluid ejectors based upon the speed variation signals.

13. A handheld printer method comprising:
receiving print data for an image;
sensing speed of movement variations amongst fluid ejectors of a handheld printer during manual movement of the handheld printer during printing of the image; and
adjusting a relative timing of fluid ejection by fluid ejectors during printing of the image based upon the sensed speed of movement variations.

14. The handheld printer method of claim 13, wherein the manual movement is along a curve having a curvature center, wherein the fluid ejectors comprise a 4 by 4 array of fluid ejectors, the 4 by 4 array of fluid ejectors comprising first and second fluid ejectors in a first column to eject a first color of fluid and third and fourth fluid ejectors in a second column to eject a second color of fluid, the first and third ejectors arranged in a first row and the third and fourth ejectors arranged in a second row, wherein the first row is radially spaced from the curvature center by first distance and wherein the second row is radially spaced from the curvature center by a second distance greater than the first distance, wherein the adjusting of the relative timing of fluid ejection by the fluid ejectors during printing the image is such fluid ejections by the first and third fluid ejectors are spaced by a first amount of time and such that fluid ejections by the second and fourth are spaced by second amount of time less than the first amount of time.

15. A non-transitory computer-readable medium comprising instructions to direct a processor to:
receive print data for an image;
sense speed of movement variations amongst fluid ejectors of a handheld printer during manual movement of the handheld printer during printing of the image; and
adjust a relative timing of fluid ejection by fluid ejectors during printing of the image as the handheld printer is moved across a print target.
